(19) United States
(12) Patent Application Publication
(10) Pub. No.: US 2007/0260560 A1
(43) Pub. Date: Nov. 8, 2007

(54) SYSTEMS AND METHODS FOR EMPLOYING PROPRIETARY DATA

(76) Inventor: Kevin Foley, New York, NY (US)

Correspondence Address: DEAN P. ALDERUCCI, CANTOR FITZGERALD, L.P., 110 EAST 59TH STREET (6TH FLOOR), NEW YORK, NY, 10022, US

(21) Appl. No.: 11/668,454

(22) Filed: Jan. 29, 2007

Related U.S. Application Data
(60) Provisional application No. 60/762,575, filed on Jan. 27, 2006.

(51) Int. Cl. G06F 17/00

(52) U.S. Cl. 705/400

(57) ABSTRACT

In at least one aspect of the invention, methods and corresponding systems are provided herewith that include the step or steps of receiving at least one order to buy or sell an item, determining an internal valuation price for the item, determining that the specified price differs from the internal price by an amount, and blocking the at least one order in response to the specified price differing from the internal price by the amount. The at least one order may be specified with a price relative to an internal valuation price for the item.

The present application claims priority to U.S. Provisional Patent Application No. 60/762,575, filed Jan. 27, 2006, which is hereby incorporated herein by reference.

### BRIEF DESCRIPTION OF THE FIGURES

FIG. 1 illustrates a system according to at least one embodiment of the systems disclosed herein; and

FIG. 2 illustrates a flowchart of a method according to at least one embodiment of the system and methods disclosed herein.

### DESCRIPTION OF THE INVENTION

The following sections I-X provide a guide to interpreting the present application.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### IV. Disclosed Examples and Terminology are not Limiting

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. § 1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

All words in every claim have the broadest scope of meaning they would have been given by a person of ordinary skill in the art as of the priority date. No term used in any claim is specially defined or limited by this application except where expressly so stated either in this specification or in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., a computer program.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VI. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VII. 35 U.S.C. § 112 paragraph 6

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of,” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also includes a computing device (e.g., a general purpose computer) that is programmed and/or configured with appropriate hardware to perform that function via other algorithms as would be understood by one of ordinary skill in the art.

### VIII. Disclaimer

Numerous references to a particular embodiment does not indicate a disclaimer or disavowal of additional, different embodiments, and similarly references to the description of embodiments which all include a particular feature does not indicate a disclaimer or disavowal of embodiments which do not include that particular feature. A clear disclaimer or disavowal in the present application shall be prefaced by the phrase “does not include” or by the phrase “cannot perform”.

### IX. Incorporation By Reference

Any patent, patent application or other document referred to herein is incorporated by reference into this patent application as part of the present disclosure, but only for purposes of written description in accordance with 35 U.S.C. § 112, paragraph 1 and enablement in accordance with 35 U.S.C. § 112, paragraph 1, and should in no way be used to limit, define, or otherwise construe any term of the present application where the present application, without such incorporation by reference, would not have failed to provide an ascertainable meaning, but rather would have allowed an ascertainable meaning for such term to be provided. Thus, the person of ordinary skill in the art need not have been in any way limited by any embodiments provided in the reference.

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### XI. Overview of Various Embodiments

Financial or other institutions and individuals, such as banks, insurance companies, brokers, etc., may possess certain proprietary data regarding certain financial instruments that are not generally available to others, such as their customers, the general public, or the market in which such instruments trade. The term “financial instrument” as used herein includes any instrument, issued by a corporation, government, or any other entity, that evinces dept or equity, and any derivative thereof, including equities, stocks, fixed income instruments, bonds, debentures, certificates of interest or deposit, warrants, options, futures, forwards, swaps, or generally any security. The term “proprietary data” includes any information that is known or otherwise available to at least one individual or entity and not know or otherwise not available to at least one other individual or entity, which may not be generally available publicly. Proprietary data may include valuation (price) information that an institution, individual, or any other party is able to ascertain in connection with the instrument.

For example, a strategist at a bank may assess the value of a particular security according to what he or she believes the price of the instrument should be. The bank may do so through estimation or any other valuation or pricing method, and may rely on previous and future (expected) market prices, returns, discount rates, and other information relevant to the pricing of the instrument. For example, a bank may assess the value of a currency in a foreign exchange market through, e.g., a modified Black-Scholes model. A bank may similarly assess the value a corporate bond by, e.g., discounting all future expected payments associated with the bond. As can be appreciated, the assessed value may not always correspond to the market price of the instrument. Accordingly, methods and systems are generally disclosed herein that may facilitate the trading of instruments or items with the use of proprietary data, such as internal price or valuation information, associated with the instruments or items.

The term internal generally denotes belonging to one of two groups. One belongs to an internal group if one or more criteria are satisfied that define the internal group. Various types of criteria may define the internal group, including memberships or affiliations. Grouping may also be hardware specific as well as individual specific. For instance, the internal group may include some or all employees of a company, members of an organization, or members of any other collective. Similarly, the internal group may include all individuals authorized to access the functionality of the system 100 as described herein. For example, the internal group may include all traders of a company or equity traders that subscribe to the trading services provided by the company. Alternatively or additionally, the internal group may include all traders authorized to access the backend functionality provided by the remote computer 106. An internal price therefore includes valuation data that is generally not available to those outside of the internal group or subsets of the internal group.

Although some of the foregoing and following discussion is presented by way of example in the context of certain businesses and institutions, such as banks, and in the context of trading and/or valuating certain items, such as currencies, fixed income securities, commodities, derivatives, or any other financial or non-financial instruments, it is understood that the systems and methods disclosed herein are applicable to other businesses, entities, and/or other items, and are therefore not limited to any one of the particular embodiments disclosed herein. The present methods and systems are generally applicable to any item that is amendable to being valued and/or being traded, e.g., purchased, sold, or otherwise exchanged.

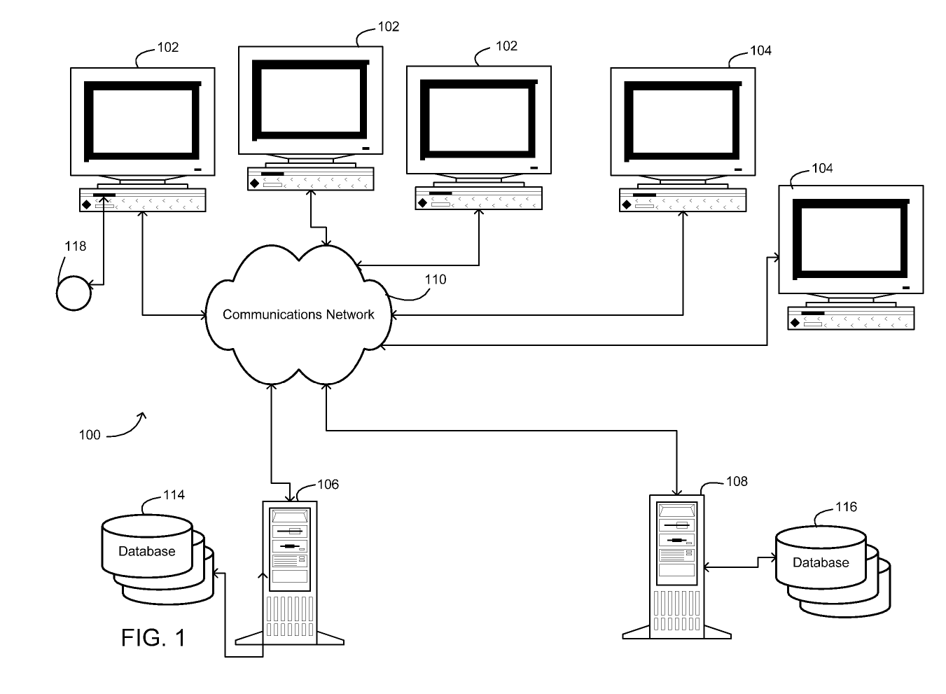

Referring to FIG. 1, a system 100, according to at least one embodiment of the systems disclosed herein, includes at least one computing device, such as a remote computer 106, e.g., a server computer, a client computer or workstation 102, or a combination thereof. The term remote in this context merely means that the remote computer 106 and at least one of the client computers 102 are separate devices. Thus, the devices may be remote even if they are located within the same room. In at least one embodiment, the system includes at least one remote computer 106 that is connected over a communication network 110 to one or a plurality of client computers 102. One or more of the client computers 102 may be connected to the remote computer 106 through a firewall. In another embodiment, at least one remote computer 106 is connected over a communication network 110 to at least one other remote computer 108.

The system 100 may be implemented over any type of communications network 110, such as a local area network (LAN), a wide area network (WAN), the Internet, a telephone network (POTS), a wireless network, including cellular, WiFi, and WiMax networks, or a combination of wired and/or wireless networks. In certain instances, the communications network 110 may be independent of the Internet or limited with respect to the type of the information transmitted over the Internet, such as to information that poses little or no security risk if misappropriated or that has been encrypted.

In the networked embodiment, client computers 102 are preferably configured or otherwise capable of transmitting and/or receiving communications to and/or from the remote computer(s) 106, 108. The remote computers 106, 108 may similarly be configured or otherwise capable of transmitting and/or receiving communications between themselves. This may be accomplished with a communication element, such as a modem, an Ethernet interface, a transmitter/receiver, etc., that enables communication with a similarly equipped remote computer 106,108 wirelessly, wired, or a combination thereof. It is understood that the relative functionality described herein may be provided by the remote computers 106, 108, by the client computers 102, or both, and is thus not limited to any particular one of the implementations discussed herein. In at least one embodiment, the client computers 102 will generally provide the front-end functionality and the remote computer 106, 108 will provide the back-end functionality.

The computing device, e.g., the client computers 102 and/or the remote computer 106, 108 generally include at least one processor, and a memory, such as ROM, RAM, FLASH, etc., including computer readable medium type memory, such as a hard drive, a flash-drive, an optical or magnetic disk, etc. The memory or computer readable medium preferably includes software stored thereon that when executed performs one or more steps of the methods disclosed herein, including communicating data and commands back and forth between the computers, displaying interface screens, etc. The computers may also be associated with or have access to one or more databases 114, 116 for retrieving and/or storing the various types of data discussed herein, including identity verification data, such as an ID and password, biometric data, etc., internal price and/or valuation data, order data, order rules, market data, account data, account and market historic data, etc.

The relevant functionality and the data discussed herein may be provided/maintained by different entities. For example, the platform the creation and trading of the items disclosed herein may be provided by an exchange or exchanges, private, e.g., over the counter (OTC) or public, etc., or any other entity. The account information may be maintained by the same entity or entities providing the trading platform or by a separate entity or entities, such as a bank or a number of banks. Additionally, clearing services for the exchange of securities and money may be provided by a clearinghouse. As such, each or all of the client devices 102, 104, remote computers 106, 108, databases, 114, 116, etc., may be within the domain of one or more of entities.

The client computers 102 may include, without limitation, a mobile phone, PDA, pocket PC, personal computer, as well as any special or other general purpose computing device. As such, the client computer 102 preferably includes a processor, a memory, a display, such as a CRT or an LCD monitor, for displaying information and/or graphics associated with the functionality provided by the system 100, and at least one input device, such as a mouse, a touch-sensitive pad, a pointer, a stylus, a trackball, a button or a plurality of buttons, e.g., alphanumeric, a scroll wheel, a touch-sensitive monitor, etc., or a combination thereof, for users to enter commands and/or information relevant to the system's functionality. With the general purpose type of client computer 102, such as the PC or PDA, users may access the functionality provided by the system 100 with a browser application or any other generic application, or with special purpose software designed specifically for accessing the functionality disclosed herein.

In at least one embodiment, the client computer 102 includes or is otherwise associated with at least one biometric sensor 118. The biometric sensor 118 is any device that is used to determine directly from the user at least one item of biometric data associated with a user, such as a fingerprint reader, an iris scanner, a retinal scanner, a vascular pattern reader, a facial recognition camera, etc. The biometric sensor 118 may be embodied in hardware, software, or a combination thereof. The biometric sensor 118 may further share resources with other components of the client computer 102, such as the processor, memory, a camera, a microphone, a speaker, etc. A single biometric sensor 118 may be used for reading more than one type of biometric data. For example, a digital camera may be used to obtain an image of the user's eye for iris scanning and an image of the user's face for facial recognition. In this instance, a single image capture of the user's face may provide the data for facial recognition as well as data for iris or retinal comparisons.

The biometric data is generally obtained with the biometric sensor 118 and used at least to authenticate the identity of the user as a gateway for allowing the user to access the system's functionality. In this regard, biometric data may be compared with previously obtained/stored biometric data that has preferably been verified as being associated with a particular user and access to the system's functionality may be provided based on a positive match thereof.

As noted above, systems and methods are provided herewith for determining, receiving, communicating, and/or generally utilizing internal, e.g., proprietary, data to control the trading of an instrument or generally any item.

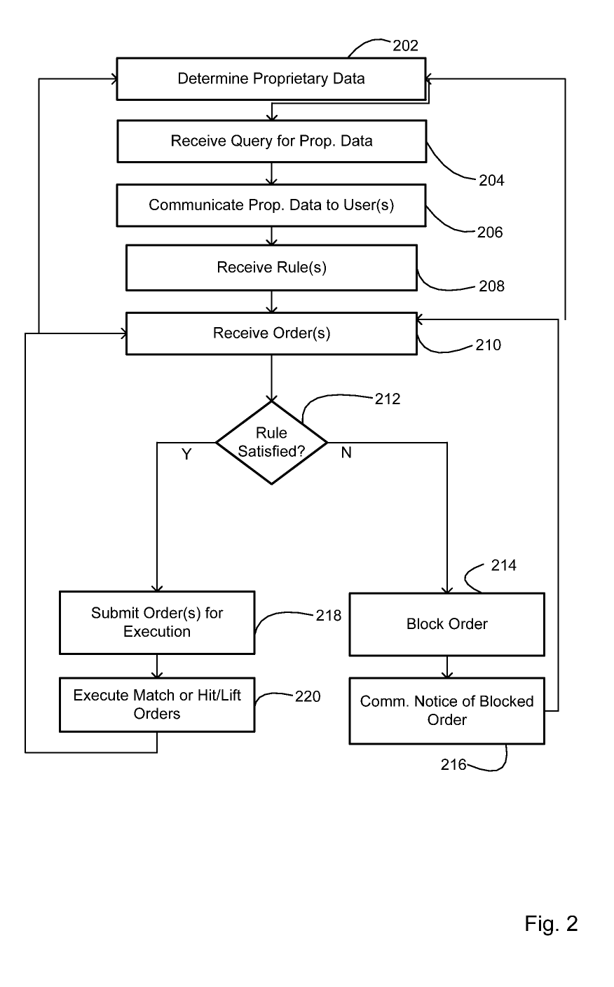

Referring to FIG. 2, a method 200 according to at least one embodiment disclosed herein, may begin at 202 with the step or steps of determining proprietary data relating to a particular instrument or item, which preferably includes a valuation price of the instrument or item, e.g., by a bank or other entity. The proprietary data may be communicated at 206 to various trading desks that are affiliated with, or are part of, the same bank or entity. A trading desk is typically a division of the bank that is involved in trading securities and that is occupied by licensed traders. Such traders usually specialize in trading a particular type of instrument such as currency (forex traders), commodities (commodities traders), equity (stock traders), etc. This may be implemented by relaying the proprietary data to one or more desk heads. A desk head—otherwise known as the head of the desk—typically oversees and controls certain aspects of the operations of one or more trading desks. The desk head, in turn, may communicate the proprietary data to one or more traders in a trading desk or may authorize the release of the data to certain customers of the bank.

The proprietary data may be communicated from one or more desk heads using client device 104 to one or more traders using client device 102. The system 100 may communicate and/or display at the client device 104 the proprietary data and preferably at least one form element therein for the desk head to select or specify one or more recipients for the data. Correspondingly, the system 100 may communicate the proprietary data to the selected traders at the client devices 102. Alternatively or additionally, the proprietary data may be stored in one or more databases, which are accessible and/or searchable by the one or more traders. In this instance, the system 100 may receive at 204 a query for proprietary data and the system 100 may in turn communicate the proprietary data to the requesting trader. The query may be general or specific, in which instances the system 100 may communicate proprietary data that satisfies the general and the specific query, respectively. For example, in response to a general query, the system 100 may communicate to the requesting user a listing of all proprietary data and in response to a specific query, the system 100 may communicate to the requesting user a listing of proprietary data that satisfies the specific query, e.g., for a specific item, item type or classe, valuation price, market price, interest or coupon rate, etc., or ranges thereof.

The proprietary data may be used in a variety of ways. The proprietary data may be used as a baseline by one or more traders for the orders on the instrument being traded at the trading desk. An order is generally a request from a trader to buy or sell a specified amount of the instrument at a specific price. The orders may be offers to buy or sell, firm or otherwise, requests for quotes or bids, indications of interest, etc. For example, the price at which the traders may trade the instrument may be pegged to the internal price communicated as part of the proprietary data.

As another example, an order placed by a trader may be a bid or offer order having a price that is set with reference to the proprietary data, e.g., the internal and/or valuation price. That is, a trader may submit and the system 100 may receive an order with reference to the proprietary data at 210. For instance, the proprietary data may include a valuation price of a certain stock XXX at $110 per share and the market price at a given time may be $99. In this instance, a trader may submit an order at a price specified a certain amount or spread above or below the internal price valuation. For example, the price may be specified as a sell at −10 or a buy at +10 with reference to the internal price, which may be submitted at 218 and executed at 220 when the market price of the stock reaches $100 and $98, respectively.

In some embodiments, the traders may be instructed, through the desk head or the customer to whom the data is made available for example, not to execute orders on the instrument at all. Alternatively, the traders may be instructed not to execute orders on the instrument specifying prices that diverge or differs from the internal price by a particular amount or spread with reference to the internal price or any other proprietary data. In this instance, the system 100 may receive or apply a relevant rule at 208, and determine at 212 if the order(s) received satisfy the rule. Orders that do not satisfy the rule may be blocked or otherwise prevented from being submitted at 214 and a notice may be communicated to the trader submitting the order at 216 indicating that the order has been blocked and/or that the order does not satisfy the rule. Orders that satisfy the rule may be submitted to, e.g., an exchange or OTC for execution at 218. The rule is generally a function of the proprietary data, e.g., the internal and/or valuation price, which rule may be security or item specific, for classes or types of securities or items, or generic for all securities or items. Orders may then be executed at 220 either with automated matching or with an acceptance, e.g., of any of the then pending orders.

The amount specified with the rule may depend on the type of instrument, the liquidity of the instrument, the trading restrictions placed on the instrument, the variation in price of the instrument, etc. Such an amount may be dictated by the desk head or may be imposed by the bank or the institution that employs the desk head. Accordingly, the orders may be adjusted by the participants in accordance with such instructions. That is, orders that do not satisfy the rule may be resubmitted with another price specified that may satisfy the rule. Alternatively, the trader submitting the order may request authorization and, in certain instances, obtain authorization to override such instructions or rules, either before a blocked trade or otherwise. In alternative embodiments, such instructions may be in the form of alerts or guidelines that either warn of a possible future restriction or that are not necessarily binding and are instead preferable practice measures.

In some embodiments, a third party, such as another bank or institution, may act as an intermediary that communicates the proprietary data from the institution or individual that determines such data or has proprietary rights in it to yet another bank or institution—e.g., traders or desk heads—authorized to receive such data. The third party may be charged with communicating the same data from one division in a bank to its traders or to other authorized traders in confidence, whenever legally allowed to do so. The owner of the proprietary data may determine which institutions and individuals, such as banks, traders and customers may be given access to such data through the third party.

For example, a particular bank or third party may relay information relating to a particular instrument from the owner of the proprietary data to the authorized traders or customers who deal in that instrument through the network. Each trader receiving such data through one of the workstations may use an interactive interface that enables him or her to trade the instrument and select whether or not to adjust orders on the instrument. The interactive interface may allow the trader to adjust his or her orders collectively. Otherwise, the trader may adjust each order individually. Moreover, the instructions, alerts and guidelines may be displayed on the interactive display and, whenever applicable, may be automatically implemented. Users may seek authorization from the desk head, customer, owner of the data or any other appropriate entity to override such instructions using the interactive interface.

One of ordinary skill in the art should appreciate that the invention may be practiced in embodiments other than those described herein, that the foregoing is only illustrative of the principles of the invention, and that various modifications can be made by those skilled in the art without departing from the scope and spirit of the invention.

What is claimed is:

1. A method comprising:
receiving at least one order to buy or sell an item, the at least one order specifying a price;
determining an internal valuation price for the item;
determining that the specified price differs from the internal price by an amount; and
blocking the at least one order in response to the specified price differing from the internal price by the amount.

2. The method of claim 1, wherein determining the internal valuation price comprises valuing the item according to a predetermined valuation model.

3. The method of claim 1, wherein the item comprises currency.

4. The method of claim 1, wherein the item comprises a fixed income instrument.

5. The method of claim 1, wherein the order specifies a price relative to the internal valuation price.

6. The method of claim 5, wherein the order specifies a spread above or below the internal valuation price.

7. The method of claim 1, comprising communicating the internal valuation price to a plurality of users at least one of which controls trading of the item; and receiving from the at least one user that controls trading a rule defining the amount for blocking the at least one order.

8. The method of claim 7, comprising receiving authorization to override the rule and executing the at least one order.

9. A method comprising:
receiving at least one order to buy or sell an item, the at least one order specifying a price relative to an internal valuation price for the item;
determining an internal valuation price for the item;
determining that the specified price differs from the internal price by an amount; and
blocking the at least one order in response to the specified price differing from the internal price by the amount.

10. A system comprising at least one computing device comprising a processor and memory having software stored thereon that when executed enables the at least one computing device to perform a method comprising:
receiving at least one order to buy or sell an item, the at least one order specifying a price;
determining an internal valuation price for the item;
determining that the specified price differs from the internal price by an amount; and
blocking the at least one order in response to the specified price differing from the internal price by the amount.

11. The system of claim 10, wherein determining the internal valuation price comprises valuing the item according to a predetermined valuation model.

12. The system of claim 10, wherein the item comprises currency.

13. The system of claim 10, wherein the item comprises a fixed income instrument.

14. The system of claim 10, wherein the order specifies a price relative to the internal valuation price.

15. The system of claim 14, wherein the order specifies a spread above or below the internal valuation price.

16. The system of claim 10, the method comprising communicating the internal valuation price to a plurality of users at least one of which controls trading of the item; and receiving from the at least one user that controls trading a rule defining the amount for blocking the at least one order.

17. The system of claim 16, the method comprising receiving authorization to override the rule and executing the at least one order.
